(19) United States
(12) Patent Application Publication
(10) Pub. No.: US 2023/0063008 A1
(43) Pub. Date: Mar. 2, 2023

(54) METHOD AND SYSTEM FOR SYNCHRONIZING COMPETETIVENESS OF TALENTS AND EMPLOYERS

(71) Applicant: Julia Ivy, Boston, MA (US)

(72) Inventor: Julia Ivy, Boston, MA (US)

(21) Appl. No.: 17/836,601

(22) Filed: Jun. 9, 2022

Related U.S. Application Data
(60) Provisional application No. 63/260,360, filed on Aug. 18, 2021.

(51) Int. Cl. G06Q 10/06; G06Q 10/10

(52) U.S. Cl. CPC G06Q 10/063112; G06Q 10/063114; G06Q 10/103

(57) ABSTRACT

A system and method for synchronizing competitive strategies of individuals that serve as Case Consultants and their potential employers that serve as Case Clients. The case client can provide challenges and the case consultant can select a challenge suitable to multidimensional nature of his profile and willingness to invest time and effort to their edge-crafting activity. The system can synchronize the progress between the case consultant and the case client using an intuitive interface and a visual map. The visual map can show the stages, instructions, templates, and progress in completing the challenge.

### CROSS-REFERENCE TO RELATED APPLICATIONS

This application claims priority from a U.S. Provisional Patent Appl. No. 60/284,917 filed on Aug. 18, 2021, which is incorporated herein by reference in its entirety.

### FIELD OF INVENTION

The present invention relates to a method, tools, and platform for synchronizing competitiveness of individuals and organizations at multiple levels.

### BACKGROUND

Enterprises always look for talents that “fit” their strategies at personal, social, professional/competitive growth, and excitement levels. The expectations regarding the “fit” go far beyond a professional fit. Multidimensional talents (e.g., millennials, career changers, veterans, and educated foreigners) also want to feel ownership for choosing a company that fits them at personal, social, professional/competitive growth, and they want to be excited with their fit.

There is no available mechanism or a place for these two parties to synchronize their strategies. Known recruitment and talent acquisition methods are limited to one level of synchronization—professional competencies, such as recruitment platforms.

A need is therefore appreciated for a method, tools, and platform that allow synchronizing competitiveness of multidimensional talents and their potential employers.

The terms “Case Consultants” used hereinafter and generally refers to edge-crafters as individuals that conduct case consulting for the companies of their personal or professional interest with the goal of crafting their competitive edge. For example, recent graduates that are still establishing their space at the job market, currently employed people that wonder “what's next?” and are interested in exploring other options in a safe environment without abrupt career moves (e.g., having sustainable but unsatisfying jobs, have an occupation but feeling that they are missing out something), established professionals at the stage of career change (e.g., veterans, recent retirees), and the like.

The “Case Clients” herein refers to employers and includes enterprises. The Case Clients provide challenges to the case consultants for case consulting and benefit from this consulting. Examples of case clients include any type of organization: businesses, nonprofit, or government agencies; direct employers looking for talents, or indirect employers that provide case consultants with experience and references for the industry of edge-crafters' interest; employers [case clients] have their organizational strategies of investing in company's competitiveness in the market while staying focused on currently relevant challenges.

The “Case Captains” herein refers to persons that can mediate synchronization between the case clients and case consultants. They are third party partners that can assist in synchronization at multiple levels. The case captains can be trained for synchronization of their strategies. These can be certified case consult coaches, industry professionals, university instructors, corporate trainers, HR trainers, or career coaches.

### SUMMARY OF THE INVENTION

The following presents a simplified summary of one or more embodiments of the present invention to provide a basic understanding of such embodiments. This summary is not an extensive overview of all contemplated embodiments and is intended to neither identify critical elements of all embodiments nor delineate the scope of any or all embodiments. Its sole purpose is to present some concepts of one or more embodiments in a simplified form as a prelude to the more detailed description that is presented later.

The principal object of the present invention is therefore directed to a system and method for synchronizing competitive strategies of individuals that serve as Case Consultants and their potential employers that serve as Case Clients.

It is another object of the present invention that the system and method can improve the operation efficiency of all involved parties.

It is still another object of the present invention that the system and method provide for better utilization of parties' resources for synchronizing their competitiveness.

It is a further object of the present invention that the system and method removed any bottlenecks in coordination of parties' efforts.

In one aspect, disclosed is a method and platform for synchronizing competitive strategies of individuals and organizations.

### BRIEF DESCRIPTION OF THE DRAWINGS

The accompanying figures, which are incorporated herein, form part of the specification and illustrate embodiments of the present invention. Together with the description, the figures further explain the principles of the present invention and to enable a person skilled in the relevant arts to make and use the invention.

FIG. 1 is a block diagram illustrating an architecture of the disclosed method, according to an exemplary embodiment of the present invention.

FIG. 2 is a diagram illustrating the module of synchronization, according to an exemplary embodiment of the present invention.

FIGS. 3A and 3B is a flowchart illustrating the disclosed methodology, according to an exemplary embodiment of the present invention.

### DETAILED DESCRIPTION

Subject matter will now be described more fully hereinafter. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, the subject matter may be embodied as apparatus and methods of use thereof. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage, or mode of operation.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely for the purpose of illustrating the general principles of the invention, since the scope of the invention will be best defined by the allowed claims of any resulting patent.

The following detailed description is described with reference to the drawings, wherein like reference numerals are used to refer to like elements throughout. In the following description, for purposes of explanation, specific details may be set forth in order to provide a thorough understanding of the subject innovation. It may be evident, however, that the claimed subject matter may be practiced without these specific details. In other instances, well-known structures and apparatus are shown in block diagram form in order to facilitate describing the subject innovation.

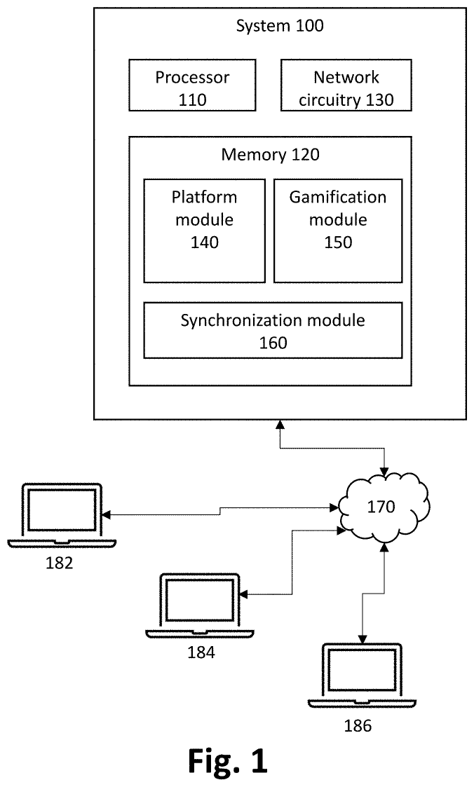

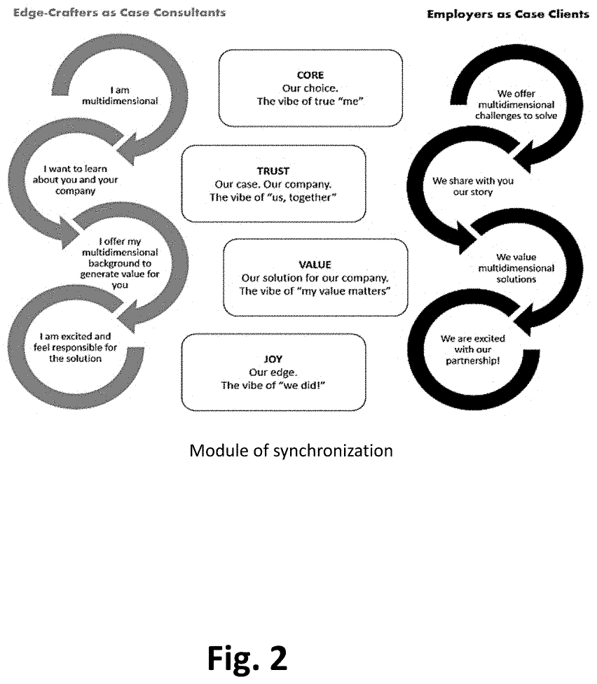

Disclosed is a system and method for synchronizing competitive strategies of individuals (aka edge-crafters) in the role of Case Consultants and organizations (aka potential employers) in the role of Case Clients. Referring to FIG. 1 which is a block diagram showing an environmental view of the disclosed system 100. FIG. 1 shows four modules of the disclosed method. A platform module 140 can provide for synchronization, a gamification module 150 can provide for clearly articulated “game” roles, action, and deliverables for participants, a synchronization module 160 can provide for strategies' synchronization.

The disclosed system 100 can include a processor 110, a memory 120, and a network circuitry 130. The modules can be implemented as an application software that can be made available through a distribution service provider, for example, Google Play™ operated and developed by Google, and the app store by Apple. In addition to the application software, a website-based interface can also be provided through the world-wide-web. The application software can also be provided for the desktop environment, such as Windows™, Linux, and macOS. The system 100 can provide a suitable interface on external devices for interacting with the disclosed system. For example, three type of interfaces can be provided including for talents 182, for employers 184, and for educators 186.

The external devices can be any computing device, such as a laptop, workstation, desktop, smartphone, tablet computer, thin client, and the like. The external devices can connect with the disclosed system through a network 170. The network can be wired or wireless. Moreover, the network can be secured or unsecured. The wired network may include Digital Subscriber Line (DSL), coaxial cable lines, or optical fiber lines. The wireless network may include BLUETOOTH, Wi-Fi, Worldwide Interoperability for Microwave Access (WiMAX), an infrared channel, or a satellite band. The wireless network may also include any cellular network standards used to communicate among mobile devices, including but not limited to standards that qualify as 3G, 4G, or 5G. The disclosed system can be implemented in an environment of a single or multiple, logically grouped servers, the servers include cloud servers. According to an exemplary embodiment, the servers may be geographically dispersed. One or more of the servers can include an operating system platform, for example, Windows, Unix, Linux, or Mac

For each the individuals, organizations, and captains, a separate login can be provided by the platform module 140 that allows secure access to the disclosed system. The login can include suitable login credentials, such a username and a password can be provided. Biometric based authentication, tokenized authentication, and password less authentication is within the scope of the present invention for gaining access to the disclosed system.

The platform module can provide an interface to the user upon login. A “user” as used herein, and throughout this disclosure, refers to an individual engaging or wish to engage a device according to embodiments of the invention to access the disclosed system. The interface can present a visual map of “synchronization” through five steps BE (intro) and E—D—G—E. Each step of the five steps on the interface can provide instructions and templates, submission button, and a report indication of how far each step is fulfilled by the other synchronizing participants. Herein after, the individuals, also referred to herein as edge crafters, play a role of Case Consultants and the representatives of potential employers play the role of Case Clients. The disclosed system provides a space and time where individuals [case consultants] and representatives of potential employers [case clients] meet to synchronize their strategies. The synchronization can be presented in a gamified form on the interface provided by the platform module. Each of the participants can play a game provided by the gamification module through solving a case. The individuals playing the role of Case Consultants can pick a challenge of their choice. To be accepted as Case Consultant, an individuals must justify a multidimensional nature of his profile and willingness to invest time and effort to their edge-crafting activity and relate their profile to the nature of Case Clients' challenges. To be accepted as Case Clients, organizations' representatives must submit a challenge statement (challenge-project, challenge-dilemma, or challenge-problem), accept the value of multidimensional expertise, and offer award/appreciation for a strongest solution. The third participant, educators, as can mediate the synchronization. To be qualified as Case Captain, educators must be trained and certified. Educators accept this role because the disclosed platform can provide them with an opportunity assisting their students with employability investment and assisting their corporate clients/employers with acquisition of talents that are tailored to their competitive strategies.

The synchronization module can provide certain sequencing actions that make the process of synchronization between individuals and organizations that both value multidimensional nature of talents and solutions happening in four levels i.e., the personal level (E), the social level (D), the professional level (G), and the level of shared excitement (E). The synchronization can be represented as below:

BE->E->D->G->E sequence presents the relationships between BE-EDGE components.

### BE—Boutique Employability:

Goal: The “BE” is the “matching” stage i.e., the first step in the synchronization. The main attention here is on recruitment of case consultants and case clients, both of which understand and value goals and outcomes of strategies' synchronization.

Action: Marketing effort on the value of investing in employability freedom and making their case as boutique talents. Recruitment of Case Consultants with a prerequisite of taking the “Is Boutique Employability for you?” test, evaluating a stock of accumulated personal, social, and professional capitals, and setting a scope of projects of their interest. Recruitment of potential Case Clients, interested in multidimensional solutions for organizational challenges. Recruitment of Case Captains from the BE-EDGE network of industry professionals, educators, and BE-EDGE alumni.

Tools: “BE—Boutique Employability” dimensions, assessment, templates, and application forms are provided.

Outcome: Recruitment of Case Consultants, Case Clients, Case Captains, motivated with the value of multidimensional tablets and boutique employability through strategy synchronization.

### E—Elucidating Professional CORE

Goal: PERSONAL LEVEL OF SYNCHRONIZATION. At this stage, Case Consultants, Case Clients, and Case Captains identify their personal “what is here for me” stakes in the process of synchronization.

Action: Case Clients launch the Challenge they want to be solved into the game. The Case Captain makes sure that the Challenge passes the 5Ws criteria. The Case Consultants listen to these pitches and make their own choices of which signs for the case that matches their interest. They might work on a case individually or form teams of 1-4 people. Case Client is approving the team to strengthen their confidence and appreciation.

Tools: “E—Your Personal Strategy” dimensions, assessment, templates, and application forms are provided.

Outcome: By the end of this stage, participants produce the “Our Choice” as a “what is here for me?” sensemaking for each of the participants of how far this game would serves as a steppingstone in achieving their goals, while synchronizing them with goals of other participants.

### D—Developing TRUST

Goal: SOCIAL LEVEL OF SYNCHRONIZATION through developing a circle of trust, where Case Consultants and Case Clients transit from the “us and them” state of two sides to the state “this is us”.

Actions: Case Consultants meet their Case Clients physically or virtually to learn and tell the company's story. Both sides must follow the “Five Shelves of the Company's Background” Framework. Case Clients share the information, and the Case Consultants collect it through the empathetic investigator techniques. After they connect with the company's reality, they conduct research of the industry and market context for the challenge. Multidimensional nature of Case consultants let them collect unexpected but relevant to the challenge. Case Consultant must avoid the “being too smart too soon” trap and do not share any conclusion, as well as the trap of “charity providers.” Instead, they must be patient, empathetic, and deep. Case Captains help both sides to stay focused on the challenge, indicated at the previous stage, and generate relevant data. They also control that Case Consultant do not find themselves in a trap. Frameworks and templates are provided.

Tools: “D—Your Social Strategy” dimensions and frameworks, assessment, video and written instructions, templates, and examples are provided (all are copyrighted).

Outcome: Case Consultants submit the “Our Company”, which must be told from multidimensional perspectives, with respect and empathy to the Case Client. Case Consultants feel welcomed and connected with Case Clients. Case Clients feel understood and appreciated. The vibe of “blanket of love” generates strong energy of “it's us, together, and we are on this challenge” resulting in professional and personal trust.

### G—Generating VALUE

Goal: PROFESSIONAL LEVEL OF SYNCHRONIZATION. Case Consultants apply their multidimensional profiles to analyze and solve the Case Client's challenge. It also justifies their value at the new for them territory.

Actions: Case Consultants apply their previously accumulated personal, social, and professional capitals for the design-thinking or problem-solving process. Multidimensional nature of the solution is key. Then they test their solution through the Case Clients' expectations and boundaries to ensure synchronization of the professional strategy with the realities of the industry. Step-by-step frameworks and templates are provided.

Tools: “G—Your Professional Strategy” dimensions and frameworks, assessment, video and written instructions, templates, and examples are provided (all are copyrighted).

Outcome: Case Consultants submit “Our Solution,” which provides them with a portfolio piece, as well as the Case Clients with tangible results. Case Clients “approve” the project with a statement of commitment, which might have an immediate or delayed commitment for implementation; be unconditional (let's do it!) or conditional (e.g., if I get investment) commitment

E—Exciting STAKEHOLDERS

Goal: synchronization at the level of SHARED EXCITEMENT in anticipation of support from external stakeholders—grant providers, investors, potential partners, or public—with the goal to receive funding or other support for the case's implementation.

Action: Case Consultants and Case Clients share a joy of presenting the case in the “Our Passion” exchange, emphasizing the multidimensional nature of developed edge, and their four levels of synchronization.

Tools: “E—Your Impression Strategy” dimensions and frameworks, assessment, video and written instructions, templates, and examples are provided (all are copyrighted).

Outcome: Investment into a competitive edge of individuals as edge-crafters [Case Consultants]. Investment into a competitive edge of potential employers [Case Clients] thanks to an innovative decision and talent acquisition. Investment into a competitive edge of Case Captains as those who know the formula of four-level synchronization between multidimensional talents and employers.

The disclosed process is highly structured and based on a special algorithm of a sequence of actions, which generate energy-charged vibes of “our choice,” “our company,” “our solution” and “our passion.” This rhythm generates a powerful energy of joint movement and shared ownership for the case they together create. The disclosed system can be implemented in three forms as illustrated in Table 1:

TABLE 1
Implementations of the disclosed system

| IMPACT | INVESTMENT | MASTERS |
|---|---|---|
| Weekend-based, open for a public, with | This form is a part of “Your CASE” | This form can be open only for graduates |
| the goal of exploring new options while | course on the art of case consulting and | from the BE-EDGE courses in the art of |
| making an impact for case clients - | “Your EDGE” course on your competitive | case consulting (the D & G course). Your |
| local small businesses, nonprofit | strategy in a professional world from the | goal is to shape your space in a team of |
| organizations, or government agencies | BE-EDGE series of courses. | your dream |
| | Your goal here is investment in your own | |
| | employability for the case client of your | |
| | choice. | |
| Case Consultants: Any edge-crafter | Case Consultants: BE-EDGE learners, interested | Case Consultants: BE-EDGE graduates |
| is welcome. | in investing in employability. | Case Clients: Businesses, interested |
| Case Clients: Nonprofits and small | Case Clients: The choice of Case Consultants | in growth, business incubators, and |
| businesses, interested in problem- | | innovation. |
| solving and partnership. | | |

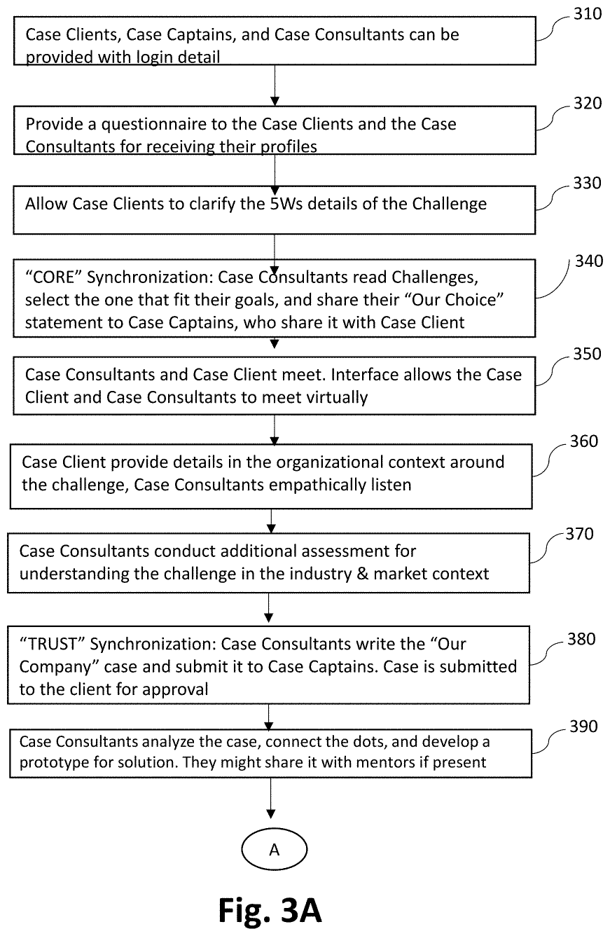

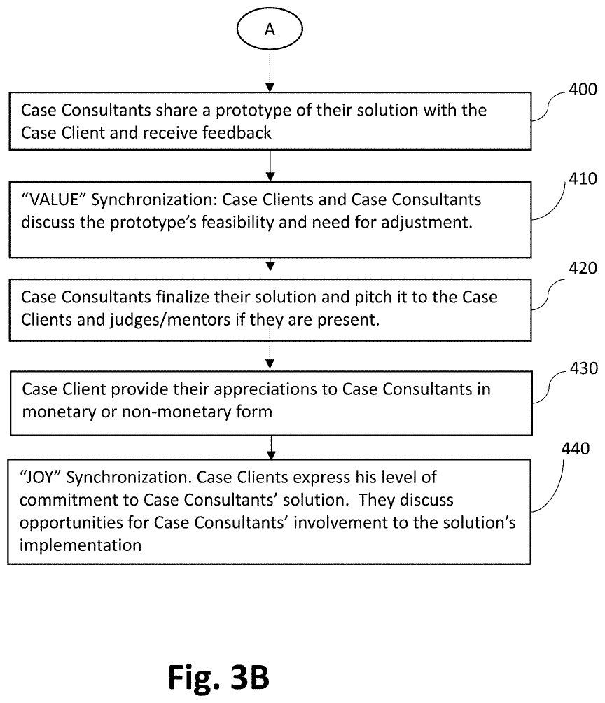

Referring to FIG. 3 which is a flowchart that illustrates the disclosed methodology. At first, the Case Clients, Case Captains, and Case Consultants can be provided with login details to securely access the disclosed system, at step 310, through respective interfaces provided by the platform module.

The platform module through an interface can provide a questionnaire to the Case Clients and the Case Captains for receiving their profiles, at step 320. The questionnaire can be presented as a form that could be filled by the Case Clients and the Case Captains. The questionnaire can also be presented as a wizard, wherein subsequent questions can be based on answers for previously asked questions. The wizard may provide options to choose from as the answers to the questions making the process of creating a profile easier and productive.

Besides the profile, the platform module can also ask for description of accumulated assets and interests. For potential Case Clients, it includes a scope of challenges that has to be solved, and the assets include the resources that would be ready to provide for solution. For potential Case Consultants, it includes a scope of challenges they want to work on, as well as stocks of personal capital, social capital, and professional capital they have accumulated. The Case Client usually goes first, while the final choice is on the Case Consultants' side. If their challenges match, the game begins.

The synchronization module can allow the Case Clients to clarify the details of the challenge through the 5Ws framework, at step 330. These challenges can be challenge-problem (I have no idea how to solve it), challenge-dilemma (I consider a couple of options for solution but need somebody help me figure out which option to proceed with), or challenge-project (I know the desired solution but need a roadmap of how to make it in the best way). The challenge cannot be a challenge-task (pls do it for me). When the challenge is submitted, Case Consultants see its indicator and click on the submitted challenge.

The Case Consultants can read the Challenge and confirm that they accept the challenge, at step 340, so the Case Client can see it. Then, at step 350, the Case Consultants who took the challenge can do assessment of the multidimensional stock of their personal, social, and professional capitals that might help to solve the challenge. They can make a “Our Choice” statement where they claim their interest, multidimensional professional readiness, and psychological fit to work on the challenge.

At step 360, the interface can allow the Case Client and Case Consultants to meet—virtually or face-to-face. It's important for them to communicate to synchronize on the social level. The Case Client tell his company's story and provides details in the organizational context around the challenge, at step 370. The synchronization module can allow the Case Consultants to receive the information for each of the category of the framework and write the “Our Company” case to demonstrate that they are together with the Case Client on their concerns and challenge, at step 380. The “Our Company” case can be submitted to the Case Client for approval, at step 390. Desirable outcome: the Case Client is touched with the level of empathy; the Case Consultants are impressed with the client.

The gamification module can allow the Case Consultants to share a prototype of their solution with the Case Client, at step 400, who commits to consider its implementation or provide feedback on how to make the solution more feasible, at step 410. The synchronization module may involve industry leaders as case mentors. Desirable outcome: Case Client is impressed with a multidimensional nature of the prototype, and willing to commit.

The Case Consultants can finalize their solution and pitch it to the Case Client and to judges/donors/investors if they are present, at step 420. The Case Client can provide their appreciations to Case Consultants in monetary or non-monetary form; donors provide their awards if they are present, at step 430. The Case Consultants can then decide on commitment regarding their involvement to the solution's implementation, at step 440.

The disclosed system can be advantageous by allowing the talents to take ownership for “crafting their space”. They strategically navigate their strategy and invest in each aspect of their interaction. They capitalize on their multidimensional profile for challenge solving and feel empowered. They feel empowered with their choices and actions.

The disclosed system assesses a probability for individuals' synchronization with a company at four levels: personal, social, professional, and excitement. The disclosed method and system are fast, highly structured, inexpensive, and based on a special algorithm of a sequence of actions. The gamification of the process can improve adaptability and compliance and provides for joint energy generation. The disclosed system can generate energy-charged vibe of a game and joint movement.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. A method for synchronizing competitive strategies of individuals as Case Consultants and organizations as a case client, the method implemented within a system comprising a processor and a memory, the method comprising:
receiving a plurality of challenges from a case client for consultation through a first interface provided by the system;
allowing a case consultant to clarify details of one or more challenges of the plurality of challenges through a second interface provided by the system;
receiving through the second interface, an acceptance of a challenge from the plurality of challenges;
receiving, an assessment of a multidimensional stock of personal, social, and professional capital, from the case consultant for solving the challenge;
allowing the case consultant and the case client to meet virtually through an interface provided by the system;
receiving a case from the case consultant for the challenge;
presenting the case to the case client for approval; and
receiving a prototype of a solution for the challenge from the case client.

2. The method according to claim 1, wherein the method further comprises the steps of:
providing a visual map on the first interface and the second interface, wherein the visual map is configured to present a synchronization between the case client and the case consultant, wherein the synchronization comprises progress made by the case consultant and the case client.

3. The method according to claim 2, wherein the method further comprises the steps of:
providing a third interface for a case captain, the third interface configured to allow mediation of the synchronization between the case client and the case consultant, wherein the visual map is also presented on the third interface.

4. The method according to claim 1, wherein the case consultant and the case client meet virtually to discuss a company profile.

5. The method according to claim 1, wherein the method further comprises the steps of:
generating, by a gamification module, video and written instruction and templates for the challenge.

6. The method according to claim 3, wherein the method further comprises the steps of:
generating login details for the case consultant, the case client, and the case captain.

7. The method according to claim 3, wherein the method further comprises the steps of:
receiving, our company case by the case consultant through the second interface from the first interface, wherein the our company case signifies the synchronization.

8. A system for synchronizing competitive strategies of multidimensional case consultants and case clients, the system comprising a processor and a memory, the system configured to implement a method comprising the steps of:
receiving a plurality of challenges from a case client for consultation through a first interface provided by the system;
allowing a case consultant to clarify details of one or more challenges of the plurality of challenges through a second interface provided by the system;
receiving through the second interface, an acceptance of a challenge from the plurality of challenges;
receiving, an assessment of a multidimensional stock of personal, social, and professional capital, from the case consultant for solving the challenge;
allowing the case consultant and the case client to meet virtually through an interface provided by the system;
receiving a case from the case consultant for the challenge;
presenting the case to the case client for approval; and
receiving a prototype of a solution for the challenge from the case client.

9. The system according to claim 8, wherein the method further comprises the steps of:
providing a visual map on the first interface and the second interface, wherein the visual map is configured to present a synchronization between the case client and the case consultant, wherein the synchronization comprises progress made by the case consultant and the case client.

10. The system according to claim 9, wherein the method further comprises the steps of:
providing a third interface for a case captain, the third interface configured to allow mediation of the synchronization between the case client and the case consultant, wherein the visual map is also presented on the third interface.

11. The system according to claim 8, wherein the case consultant and the case client meet virtually to discuss a company profile.

12. The system according to claim 8, wherein the method further comprises the steps of:
generating, by a gamification module, video and written instruction and templates for the challenge.

13. The system according to claim 10, wherein the method further comprises the steps of:
generating login details for the case consultant, the case client, and the case captain.

14. The system according to claim 10, wherein the method further comprises the steps of:
receiving, our company case by the case consultant through the second interface from the first interface, wherein the our company case signifies the synchronization.
